(19) United States
(12) Patent Application Publication
(10) Pub. No.: US 2014/0373138 A1
(43) Pub. Date: Dec. 18, 2014

(54) METHOD AND APPARATUS FOR PREVENTING DISTRIBUTED DENIAL OF SERVICE ATTACK

(71) Applicants: Chan Hee Park, Suwon-si (KR); Woo Kyum Kim, Gangnam-gu (KR)

(72) Inventors: Chan Hee Park, Suwon-si (KR); Woo Kyum Kim, Gangnam-gu (KR)

(73) Assignee: AHNLAB, INC., Gyeonggi-do (KR)

(21) Appl. No.: 14/122,364

(22) PCT Filed: Jun. 26, 2012
(86) PCT No.: PCT/KR2012/005043

§ 371 Date: Nov. 26, 2013

(30) Foreign Application Priority Data
Jun. 27, 2011 (KR) 10-2011-0062126

(51) Int. Cl. H04L 29/06

(52) U.S. Cl. CPC H04L 63/1458; H04L 63/08
USPC 726/22

(57) ABSTRACT

An apparatus for preventing a distributed denial of service (DDoS) attack transmits a redirect message containing a redirect URL (Uniform resource Locator) to a client terminal that has transmitted a request for accessing a web server, in place of the web server. The apparatus authenticates the client terminal that re-sends the request for accessing the web server as a normal client terminal, and permits the client terminal to access the web server.

### TECHNICAL FIELD

The present invention relates to a technique of preventing a distributed denial of service (DDoS) attack, and more particularly, to an apparatus and method for preventing a DDoS attack from multiple unspecified client terminals based on redirect URL (Uniform Resource Locator).

### BACKGROUND ART

A distributed denial of service (DDoS) attack refers to a harmful action that multiple unspecified attackers send large masses of data to a target web server for the purpose of disturbing normal services provided by the target web server so that the per-formance of the target web server is abruptly degraded to make the service unavailable.

DDoS attacks may be roughly classified into a network level attack and an application level attack. The network level attack represents an attack performed at a network level or layer, such as transmission control protocol (TCP) flooding, user datagram protocol (UDP) flooding, and internet control message protocol (ICMP) flooding. The application level attack represents an attack performed at an application layer, such as hypertext transfer protocol (HTTP) flooding, session initiation protocol (SIP) flooding, and domain name server (DNS) flooding.

One of the most widely used methods for counteracting to the DDoS attacks is a threshold test method for measuring an amount of traffic requested to a target web server, and dropping packets for a certain amount of time if the measured amount of the traffic exceeds a preset threshold.

However, the threshold test method is problematic in effectively detecting and preventing a DDoS attack because a threshold for identifying attacking IP addresses cannot be specified in the event of an actual attack with a large number of the attacking IP addresses.

Moreover, to make up for the problem encountered in the threshold test method, there was suggested a method for distinguishing between normal users and attackers to prevent traffic generated by the attackers. However, it is difficult to implement the identification of the normal users without affecting service targeting unspecified individuals, except in the case of some protocols.

### DISCLOSURE OF INVENTION

### Technical Problem

In view of the above, the present invention provides an apparatus and method for preventing a DDoS attack from multiple unspecified client terminals based on redirect URL (Uniform Resource Locator).

### Solution to Problem

In accordance with an embodiment of the present invention, there is provided an apparatus for preventing a distributed denial of service (DDoS) attack, the apparatus including: a communication unit configured to receive a packet requesting an access to a web server from a client terminal in place of the web server; a packet processing unit configured to analyze the received packet and extract packet information including at least one of internet protocol (IP) address and hypertext transfer protocol (HTTP) information from the received packet; and a control unit configured to check the IP address of the client terminal using the packet information, providing a redirect URL (Uniform Resource Locator) message for authentication to the client terminal, identify the client terminal re-sending a request of a redirect URL for accessing the web server, authenticate the client terminal as a normal client terminal, and permit the access to the web server.

In the embodiment, the redirect message includes the redirect URL having cookie information contained in the redirect URL.

In the embodiment, the cookie information is created using a source IP address of the packet.

In the embodiment, the redirect message is transmitted using an HTTP 302 redirect response to the client terminal, using an HTTP 200 OK response having a script to move to the redirect URL to the client terminal, or using an HTTP 200 OK response to the client terminal.

In the embodiment, the script is written in a Java script or visual basic (VB) script.

In the embodiment, the redirect message is included in a HTML (Hyper Text Markup Language) page having a link to the redirect URL.

In the embodiment, the apparatus further includes a white list DB having a whitelist in which IP addresses of one or more client terminals which have been succeeded in the authentication is registered.

In the embodiment, the control unit is further configured to check whether or not the IP address of the client terminal requesting an access to the web server is registered in the whitelist, and if an IP address of the client terminal is registered in the whitelist, permit the client terminal to access the web server.

In the embodiment, the whitelist is updated if a predetermined amount of time is elapsed or a predetermined number of times of access requests is exceeded, by performing the authentication on the client terminals, each having the IP address registered in the whitelist.

In the embodiment, the packet processing unit includes: a packet receiver configured to receive the packet in place of the web server; a packet analyzer configured to analyze the packet and check the IP address, protocol information, or HTTP information of the received packet; and a packet transmitter configured to transmit the redirect message to the client terminal.

In the embodiment, when there is an access request from a client terminal using a non-TCP (Transmission Control Protocol), the control unit is configured checks whether or not an IP address of the client terminal is registered in the whitelist, and if the IP address is not registered in the whitelist, drops the access request from the client terminal.

In the embodiment, wherein the non-TCP protocol includes a user datagram protocol (UDP), and an internet control message protocol (ICMP).

In accordance with another embodiment of the present invention, there is provided a method for preventing a distributed denial of service (DDoS) attack, the method including: receiving a packet requesting an access to a web server from a client terminal in place of the web server; checking internet protocol (IP) address of the client terminal based on the received packet; transmitting a redirect URL (Uniform Resource Locator) message to the client terminal requesting an access to a web server; checking whether or not a request of a redirect URL for accessing the web server is received from the client terminal; if the request of a redirect URL is received, authenticating the client terminal as a normal client terminal; and permitting the authenticated client terminal to access the web server.

In the embodiment, the method further includes registering an IP address of the authenticated client terminal in a whitelist.

In the embodiment, the method further includes: if there is an access request from a client terminal using a TCP (Transmission Control Protocol), checking whether or not an IP address of the client terminal is registered in the whitelist; and if the IP address of the client terminal is registered in the whitelist, permitting the client terminal to access the web server.

In the embodiment, the method further includes: if there is an access request from a client terminal using a non-TCP protocol, checking whether or not an IP address of the client terminal is registered in the whitelist; and if the IP address is not registered in the whitelist, dropping the access request.

In the embodiment, the redirect message includes the redirect URL having cookie information therein.

In the embodiment, the redirect message includes the redirect URL having cookie information contained in the redirect URL.

In the embodiment, the cookie information is created using a source IP address of the packet.

In the embodiment, the redirect message is transmitted using an HTTP (Hypertext Transfer Protocol) 302 redirect response to the client terminal, using an HTTP 200 OK response having a script to move to the redirect URL to the client terminal, or using an HTTP 200 OK response to the client terminal.

In the embodiment, the script is written in a Java script or visual basic (VB) script.

In the embodiment, the redirect message is included in an HTML (Hyper Text Markup Language) page having a link to the redirect URL.

### BRIEF DESCRIPTION OF DRAWINGS

The above and other objects and features of the present invention will become apparent from the following description of embodiments, given in conjunction with the accompanying drawings, in which:

FIG. 1 is a block diagram of a computer network system to which an embodiment of the present invention is applied;

FIG. 2 illustrates a detailed block diagram of an apparatus for preventing a DoS attack illustrated in FIG. 1 in accordance with an embodiment of the present invention;

FIG. 3 illustrates a sequential diagram illustrating a method for preventing a DoS attack in accordance with an embodiment of the present invention; and

FIG. 4 illustrates a sequential diagram illustrating a method for filtering unauthenticated IP addresses of client terminals using UDP/ICMP protocol in accordance with embodiment of the present invention.

### BEST MODE FOR CARRYING OUT THE INVENTION

Hereinafter, embodiments of the present invention will be described with reference to the accompanying drawings.

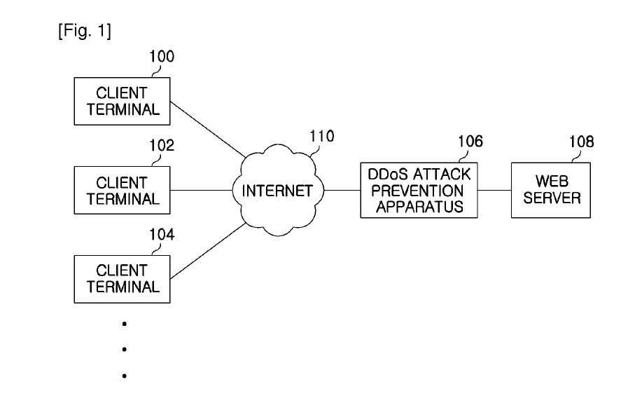

FIG. 1 is a block diagram of a computer network system to which an embodiment of the present invention is applied. Referring to FIG. 1, a plurality of client terminals 100, 102, and 104 is a user terminal used for accessing a web server 108 for providing user-desired services via a communication network such as the Internet 110 or the like. Examples of such client terminals may include a personal computer (PC), a personal digital assistant (PDA), a mobile phone, a Portable Multimedia Player (PMP), and a smart phone, and the like, which have a capability of accessing the web server via the Internet 110.

When there is an access request to the web server 108 issued by a user who posses any one of the client terminals, e.g., a client terminal 100, a transmission control protocol (TCP) connection is established between the client terminal 100 and the web server 108. The client terminal 100 then transmits to the web server 108 an HTTP request for a resource on the web server by sending a URL (Uniform Resource Locator) for the resource in a packet of the request. In response to the request, the client terminal 100 then receives a response of the resource from the web server 108.

The web server 108 refers to a system which is connected to the Internet 110 and provides a user-desired service to the client terminal 100. Examples of the web server 108 may include, but not limited to, a portal site server, a government office server, an open market server, and so on. Upon receiving the HTTP request from the client terminal 100, the web server 108 provides the resource of the URL to the client terminal 100. A web page or the like related to the resource is displayed on the client terminal 100, whereby the user of the client terminal 100 may enjoy the service provided by the web server 108.

The DDoS attack prevention apparatus 106, which is disposed on the computer network system, is configured to receive the HTTP request from the client terminal 100, on the behalf of the web server 108, and determines whether the HTTP request transmitted from the client terminal 100 is normal traffic or attacking traffic. If the HTTP request is traffic for attacking the web server 108, the DDoS attack prevention apparatus 106 drops the HTTP request from the client terminal 100 to prevent a DDoS attack.

More specifically, when the DDoS attack prevention apparatus 106 receives the HTTP request from the client terminal 100, the DDoS attack prevention apparatus 106 establish a TCP connection with the client terminal 100 in place of the web server 108 and analyzes the packet of the HTTP request and checks internet protocol (IP) address, protocol information, and hypertext transfer protocol (HTTP) information of the packet. Next, the DDoS attack prevention apparatus 106 does not send the resource requested from the client terminal 100 directly to the client terminal 100, but provides, to the client terminal 100, a redirect message including cookie information having a redirect URL to be redirected, i.e., a URL of the DDoS attack prevention apparatus 106 and then closes the TCP connection with the client terminal 100.

Having received the redirect message, the client terminal 100 analyzes the cookie information included in the redirect message and, and re-sends the HTTP request to the DDoS attack prevention apparatus 106. The DDoS prevention apparatus 106 then checks whether or not the client terminal 100 re-sends the HTTP request accurately. If the check result is affirmative, the DDoS prevention apparatus 106 performs an authentication of the client terminal 100 as a normal client terminal. If not, however, the DDoS attack prevention apparatus 106 drops the HTTP request from the client terminal 100 to prevent a DDoS attack.

For example, in case where the client terminal 100 is infected with a DDoS attack program installed unawares to the user, the client terminal 100 repetitively sends the same HTTP request to the web server 108. Thus, although the client terminal 100 receives the redirect message from the DDoS attack prevention apparatus 106, the client terminal 100 does not properly analyze the cookie information included in the redirect message and thus are unable to re-send the request to the DDoS attack prevention apparatus 106. The DDoS attack prevention apparatus 106 then determines that the client terminal 100 that re-sends the request accurately as a normal client terminal, but that the client terminal 100 that is incapable of re-sending the request as an attacking client terminal and cuts off the request from the client terminal, thereby preventing a DDoS attack.

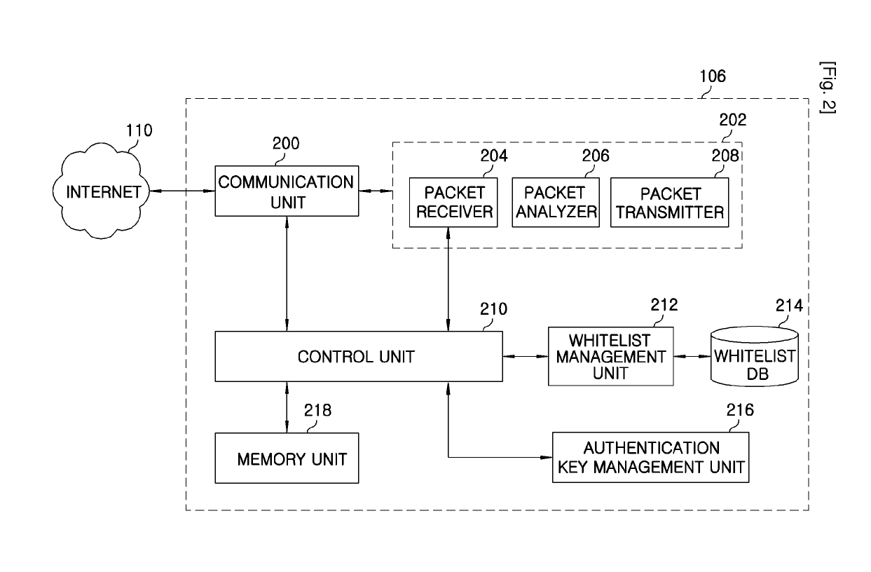

FIG. 2 shows a detailed block diagram of the DDoS attack prevention apparatus illustrated in FIG. 1 in accordance with an embodiment of the present invention. The DDoS attack prevention apparatus 106 includes a communication unit 200, a packet processing unit 202, an authentication key management unit 216, a control unit 210, and a whitelist management unit 212. The packet processing unit 202 includes packet receiver 204, a packet analyzer 206 and a packet transmitter 208.

The communication unit 200 receives a packet of an HTTP request for a resource on the web server 108 which contains a URL (Uniform Resource Locator) for the resource, on behalf of the web server 108, from the respective client terminals, 100, 102 and 104. For example, the communication unit 200 may be a network interface device to provide wireless/wired communication.

Upon receiving the packet of the HTTP request from one of the client terminals, for example, the client terminal 100, the packet processing unit 202 analyzes the received packet, checks packet information such as IP address, protocol information, HTTP information and the like of the received packet, and provides the packet information to the control unit 210. Further, the packet processing unit 202 receives a redirect message including cookie information containing a redirect URL from the control unit 210, and transmits the redirect message to the client terminal 100 after formatting thereof via the communication unit 200.

In the packet processing unit 202, the packet receiver 204 receives the packet of the HTTP request from the client terminal 100 and converts the packet into a packet format adapted for in the DDoS attack prevention apparatus 106. The packet analyzer 206 analyzes the packet from the client terminal 100 and checks the IP address, protocol information, HTTP information and the like of the packet. In order to identify whether or not the client terminal 100 is a normal client terminal, the packet transmitter 208 transmits the redirect message generated by the control unit 210 to the client terminal 100 via the communication unit 202.

The control unit 210 controls the overall operation of the DDoS attack prevention apparatus 106 depending on an operation program stored in a memory unit 218. Further, the control unit 210 identifies traffic format, the IP address and the like of the client terminal 100, using the IP address, protocol information, HTTP information and the like of the received packet, and provides the redirect message including cookie information to the client terminal 100. Further, the control unit 210 checks whether or not the client terminal 100 accurately re-sends the HTTP request to the redirect URL, and permits or drops the packet from the client terminal 100.

That is, in the case of receiving the packet of the HTTP request from the client terminal 100, the control unit 210 does not directly send the resource of the URL requested from the client terminal 100, but provides the redirect message including cookie information having a redirect URL to be redirected in order for authenticating the client terminal 100.

The client terminal 100 receives the redirect message from the DDoS attack prevention apparatus 106. If the client terminal 100 is a normal client terminal, the client terminal 100 analyzes the cookie information included in the redirect message, and then re-sends the packet of the HTTP request to the DDoS attack prevention apparatus 106 having the redirect URL. Accordingly, the DDoS attack prevention apparatus 106 identifies the client terminal that has re-sent the packet of the request as a normal terminal.

On the contrary, if the client terminal 100 is a terminal for DDoS attack, the client terminal 100 does not properly analyze the cookie information included in the redirect message, and hence does not re-send the request for accessing the web server 108 to the DDoS attack prevention apparatus 106. If no packet of the request is received from the client terminal 100, the control unit 210 determines the packet is for a DDoS attack, and drops the packet from the client terminal 100.

The way of guiding to re-send the request for accessing the web server to the redirect URL and authenticating a client terminal re-sending the request includes three methods, “302 Found”, “Java-Script” and “manual input by a user” as follows.

First, if “302 Found” is used as a way of authenticating a client terminal, the control unit 210 transmits the redirect message using an HTTP 302 redirect response to the client terminal.

In response to the redirect message, the client terminal needs to try again to establish a TCP connection with the DDoS attack prevention apparatus 106, and re-send the request for accessing the web server 108 to the DDoS attack prevention apparatus 106 having the redirect URL.

If the DDoS attack prevention apparatus 106 receives the request for accessing the web server 108 from the client terminal, it determines the client terminal as a normal client terminal. However, if the DDoS attack prevention apparatus 106 receives no request for accessing the web server 108 from the client terminal, it determines the client terminal as an abnormal client terminal, and drops the request from the client terminal.

Second, for example, if a script is used as a way of authenticating the client terminal, the control unit 210 transmits the redirect message using an HTTP 200 OK response to the client terminal. The HTTP 200 OK response is written in a script to move to the redirect URL using a Java script or visual basic (VB) script.

In response to the redirect message, the client terminal needs to interpret the script, try again to establish a TCP connection with the DDoS attack prevention apparatus 106, and then re-send the request for accessing the web server 108 to the DDoS attack prevention apparatus 106 having the redirect URL.

If the DDoS attack prevention apparatus 106 receives the request for accessing the web server 108 from the client terminal, it determines the client terminal as a normal client terminal. However, if the DDoS attack prevention apparatus 106 receives no request for accessing the web server 108 from the client terminal, it determines the client terminal as an abnormal client terminal, and drops the request from the client terminal.

Third, for example, if a manual input by a user is used as a way of authenticating the client terminal 100, the DDoS attack prevention apparatus transmits the redirect message using an HTTP 200 OK response to the client terminal. In this connection, the HTTP 200 OK response includes an HTML page having a link to a redirect URL.

In this case, the link in the HTML page is displayed on the client terminal, and a user of the client terminal directly clicks the link on the HTML page to request a URL for accessing the web server 108 to the DDoS attack prevention apparatus 110.

If the DDoS attack prevention apparatus 106 receives the request of the URL for accessing the web server 108 from the client terminal 100, it determines the client terminal as a normal client terminal. However, if the DDoS attack prevention apparatus 106 receives no request for accessing the web server 108 from the client terminal, it determines the client terminal as an abnormal client terminal, and drop the request from the client terminal.

In other words, the DDoS attack prevention apparatus 106 allows the client terminals 100, 102, and 104 to analyze the redirect message and re-send the request for accessing the web server 108 to the DDoS attack prevention apparatus 106. Accordingly, abnormal client terminals cannot respond to the redirect message, thereby preventing the DDoS attack.

Meanwhile, the authentication key management unit 216 generates cookie information used for the authentication of the client terminals and provides the cookie information to the control unit 210.

The cookie information used for authentication is created using a source IP address of the packet of the HTTP request. This is for preventing wrong authentication when an attacker generates random URLs for attack. Further, in case of a TCP connection from a fake IP address, the DDoS attack prevention apparatus 106 may adjust the number of times and intervals of response to the TCP connection described above. This is for preventing the generation of unnecessary traffic such as a DDoS attack during the DDoS attack prevention apparatus 106 continually responds to a TCP connection without limit in the number of times.

Further, the authentication key management unit 216 determines whether or not the cookie information extracted from the packet transmitted from the client terminals 100, 102, and 104 is normal and provides the determination result to the control unit 210.

The whitelist management unit 212 stores and manages IP addresses of the client terminals 100, 102, and 104 authenticated as normal client terminals in a whitelist DB 214. When performing an authentication of the client terminals 100, 102, and 104 in response to the request for accessing the web server 108 from the client terminals, the IP addresses of the client terminals 10, 102, and 104 are searched in the whitelist DB 214 to see whether or not they are registered in the whitelist DB 214, and the search result is provided to the control unit 210. Further, re-authentication may be performed on the IP addresses of the client terminals 100, 102, and 104 registered in the whitelist DB 214 in case where a preset amount of time is elapsed or a designated number of times of access requests is exceeded. In this case, the IP addresses requiring the re-authentication may be deleted from the whitelist DB 214 and newly authenticated IP addresses may be updated in the whitelist DB 214.

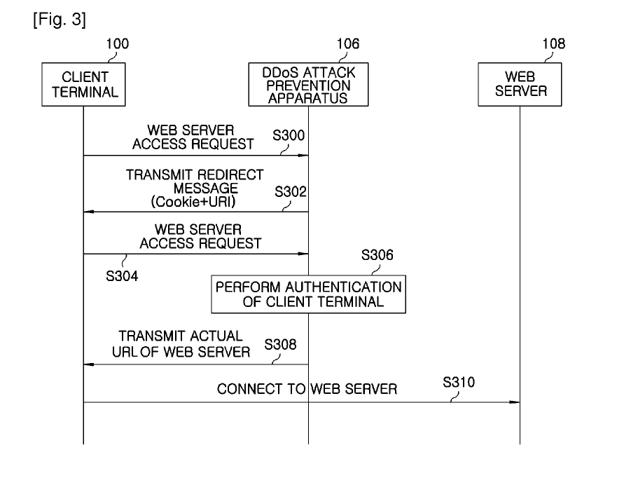

FIG. 3 illustrates a sequential diagram illustrating a method for preventing a DoS attack in accordance with an embodiment of the present invention.

First, in step S300, when a request for accessing the web server 108 is issued from any one of the client terminals, e.g., a client terminal 100, the DDoS attack prevention apparatus 106 receives the request from the client terminal 100, and performs a TCP connection with the client terminal 100 in place of the web server 108.

Next, the DDoS attack prevention apparatus 106 transmits a redirect message including cookie information containing a redirect URL to the client terminal 100 in step S302, and then closes the TCP connection.

For “302 Found”, the redirect message is transmitted using an HTTP 302 redirect response.

For a script used for authentication of the client terminal 100, the redirect message is transmitted using an HTTP 200 OK response to the client terminal 100, wherein the HTTP 200 OK response includes a script to move to the redirect URL which is written in a Java script or VB script.

In addition, for a manual input by a user, a redirect message is transmitted in an HTTP 200 OK response to the client terminal 100. In this connection, the HTTP 200 OK response includes an HTML page having a link to a redirect URL. The link on the HTML page is then displayed on the client terminal 100, and a user of the client terminal 100 directly clicks the link to re-send the request for accessing the web server 108 to the DDoS attack prevention apparatus 110.

Upon receiving the redirect message from the DDoS attack prevention apparatus 106, in step S304, the client terminal 100 analyzes the cookie information included in the redirect message, tries to establish a TCP connection with the DDoS attack prevention apparatus 106, and then re-sends the request for accessing the web server 108 to the DDoS attack prevention apparatus 106. When the request from the client terminal 100 is accurately received to the DDoS attack prevention apparatus 106, in step S306, the DDoS attack prevention apparatus 106 performs authentication of the client terminal 100 using the cookie information from the client terminal 100 and the IP address of the client terminal 100. That is, the DDoS attack prevention apparatus 106 determines whether or not the request from the client terminal 100 is accurately received, and authenticates the client terminal 100 that has sent the URL request accurately as a normal client terminal.

Next, if the authentication is successful, the DDoS attack prevention apparatus 106 provides the IP address of the client terminal 100 to the whitelist management unit 212 so that the IP address of the client terminal 100 is registered in the whitelist DB 214, and provides an actual URL of the resource on the web server 108, which is requested by the client terminal 110, without the cookie information to the client terminal 100 in step S308.

Since the client terminal 100 has been authenticated by the DDoS attack prevention apparatus 106, the DDoS attack prevention apparatus 106 allows the client terminal 100 to pass the request from the client terminal 110 to the web server 108, thereby enabling the client terminal 100 to access the web server 108 using the actual URL provided from the DDoS attack prevention apparatus 106 in step S310.

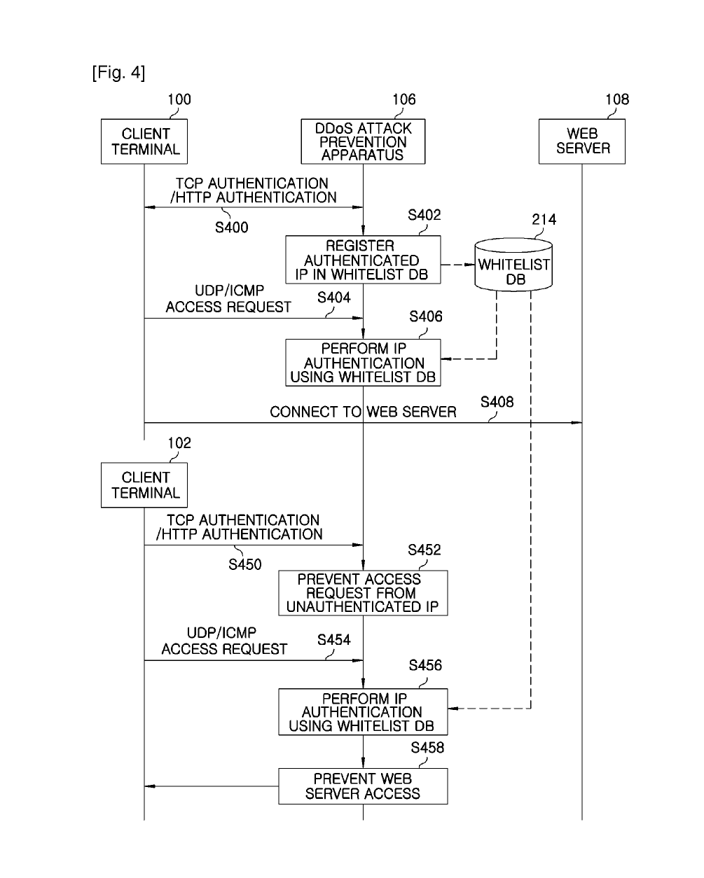

FIG. 4 illustrates a sequential diagram illustrating a method for filtering unauthenticated IP addresses of client terminals using UDP/ICMP protocol not TCP protocol in accordance with embodiment of the present invention. In FIG. 4, it is assumed that a client terminal 100 is a terminal of a normal user and a client terminal 102 is a terminal of an attacker.

First, in step S400, the DDoS attack prevention apparatus 106 performs TCP authentication/HTTP authentication on the respective client terminals including the client terminal 100, which request a HTTP request for accessing the web server 108, through the use of the authentication methods as described with reference to FIG. 3.

In step S402, the DDoS attack prevention apparatus 106 registers IP addresses of the client terminals having succeeded in authentication in the whitelist DB 214.

In this regard, the client terminal 100 may access the web server 108, depending on available services, using other transmission layer protocols, such as a UDP, ICMP protocol or the like, than the TCP protocol. For the UDP or ICMP protocol, a request for accessing the web server is mostly issued after making a TCP connection. Thus, when there is the request using not the TCP protocol but the UDP or ICMP protocol from the client terminal 100 in step S404, the DDoS attack prevention apparatus 106 extracts an IP address of the client terminal 100 from a packet transmitted using the UDP or ICMP protocol, and then checks whether or not the IP address of the client terminal 100 is one of the IP addresses registered in the whitelist DB 214 in order to authenticate the client terminal 100 in step S406.

In step S408, the client terminal 100, which has been registered in the whitelist DB 214, can make a connection to the web server 108 and enjoy an available service from the web server 108. As described above, the access request from the client terminal using the UDP or ICMP protocol can be detected by checking whether the IP address of the client terminal is one of the IP addresses of the authenticated client terminals.

Meanwhile, if there is an access request through a TCP connection from the client terminal 102 of an attacker, the DDoS attack prevention apparatus 106 performs the same TCP authentication/HTTP authentication of the client terminal 100 through the use of the authentication methods as described with reference with FIG. 3, in step S450.

The client terminal 102 of an attacker, unlike the client terminal 100, does not properly respond to the authentication procedure using the redirect message performed by the DDoS attack prevention apparatus 106, thus failing in the HTTP authentication. Therefore, the DDoS attack prevention apparatus 106 drops the web access request from the client terminal 102 in step S452.

In this state, if the client terminal 102, which is prevented from making a TCP connection, transmits an access request using the UDP or ICMP protocol, in step S454, the DDoS attack prevention apparatus 106 extracts the IP address of the client terminal 102 from the packet transmitted using the UDP or ICMP protocol, and then checks whether or not the IP address of the client terminal 102 is registered in the whitelist DB 214 in step S456. If the IP address is not any one of the registered IP addresses in the whitelist DB 214, the DDoS attack prevention apparatus 106 determines the client terminal 102 as a terminal of an attacker and the prevents the access request using the UDP or ICMP in step S458.

As described above, in case of the access request from client terminals having unauthenticated IP addresses using a non-TCP protocol such as the UDP or ICMP protocol, it is difficult to authenticate that the client terminals is normal. Thus, a method of filtering the client terminals using UDP or ICMP protocol is performed based on the whitelist derived from the HTTP-based client authentication.

Meanwhile, the filtering method of the client terminals having unauthenticated IP addresses using the UDP or ICMP protocol may be achieved by, for example, anti-spoofing filter authentication and BotNet filter authentication.

Further, based on the anti-spoofing filter authentication and BotNet filter authentication, two types of filtering modes are implemented to prevent a client terminal of an attacker. The filtering method may include a general filtering mode and an advanced filtering mode. The general filtering mode is a mode that permits only a client terminal included in a whitelist derived from the anti-spoofing filter authentication or BotNet Filter authentication, that is, a mode that permits a client terminal having an authenticated IP address that is a non-spoofed IP address; whereas the advanced filtering mode is a mode that permits only a client terminal included in a whitelist derived from the BotNet Filter authentication, that is, a mode that drops even a non-spoofed IP address in case of abnormal HTTP use.

While the embodiments have been shown and described with respect to the particular examples, the embodiments are not limited thereto. It will be understood by those skilled in the art that various changes and modification may be made without departing from the scope of the embodiments as defined in the following claims.

1. An apparatus for preventing a distributed denial of service (DDoS) attack, the apparatus comprising:
a communication unit configured to receive a packet of a request for accessing a web server from a client terminal in place of the web server;
a packet processing unit configured to analyze the received packet and extract packet information including at least one of internet protocol (IP) address and hypertext transfer protocol (HTTP) protocol information from the received packet; and
a control unit configured to check the IP address of the client terminal using the extracted information, provide a redirect message containing a redirect URL (Uniform resource Locator) to the client terminal, authenticate the client terminal that has re-sent the request for accessing the web server to the redirect URL as a normal client terminal, and permit the client terminal to access the web server.

2. The apparatus of claim 1, wherein the redirect message includes cookie information containing the redirect URL.

3. The apparatus of claim 2, wherein the cookie information is created using a source IP address of the packet.

4. The apparatus of claim 1, wherein the redirect message is transmitted using an HTTP 302 redirect response to the client terminal.

5. The apparatus of claim 1, wherein the redirect message is transmitted using an HTTP 200 OK response having a script to move to the redirect URL to the client terminal.

6. The apparatus of claim 5, wherein the script is written in a Java script or visual basic (VB) script.

7. The apparatus of claim 1, wherein the redirect message is transmitted using an HTTP 200 OK response to the client terminal, wherein the redirect message includes an HTML (Hyper Text Markup Language) page having a link to the redirect URL.

8. The apparatus of claim 1, further comprising a white list DB having a whitelist in which IP addresses of one or more client terminals which have been authenticated is registered.

9. The apparatus of claim 8, wherein the control unit is further configured to check whether or not an IP address of the client terminal transmitted the request for accessing the web server is registered in the whitelist, and if the IP address of the client terminal is any one of the registered IP addresses in the whitelist, permit the client terminal to access the web server.

10. The apparatus of claim 8, wherein the whitelist is updated by performing again the authentication of the client terminals, each client terminal having the IP address registered in the whitelist if a predetermined amount of time is elapsed or the number of times of the request for accessing the web server is exceeded a predetermined number of times.

11. The apparatus of claim 1, wherein the packet processing unit includes:
a packet receiver configured to receive the packet in place of the web server;
a packet analyzer configured to analyze the packet and check the IP address, protocol information, or HTTP information of the received packet; and
a packet transmitter configured to transmit the redirect message to the client terminal.

12. The apparatus of claim 8, wherein, when there is the request for accessing the web server from a client terminal using a non-TCP protocol, the control unit is configured check whether or not an IP address of the client terminal is registered in the whitelist, and if the IP address is not any one of the registered IP addresses in the whitelist, drops the access request from the client terminal.

13. The apparatus of claim 12, wherein the non-TCP protocol includes a user datagram protocol (UDP), and an internet control message protocol (ICMP).

14. A method for preventing a distributed denial of service (DDoS) attack, the method comprising:
receiving a packet of a request for accessing a web server from a client terminal in place of the web server;
checking internet protocol (IP) address of the client terminal based on the received packet;
transmitting a redirect message containing a URL (Uniform Resource Locator) to be redirected to the client terminal;
checking whether or not the request for accessing the web server is received from the client terminal using the redirect message;
if the request for accessing the web server is received, authenticating the client terminal as a normal client terminal; and
permitting the authenticated client terminal to access the web server.

15. The method of claim 14, further comprising:
registering an IP address of the authenticated client terminal in a whitelist.

16. The method of claim 15, further comprising:
if there is a request for accessing the web server from a client terminal using a TCP (Transfer Control Protocol), checking whether or not an IP address of the client terminal is registered in the whitelist; and
if the IP address of the client terminal is any one of the registered IP addresses in the whitelist, permitting the client terminal to access the web server.

17. The method of claim 15, further comprising:
if there is a request for accessing the web server from a client terminal using a non-TCP, checking whether or not an IP address of the client terminal is any one of the registered IP addresses in the whitelist; and
if the IP address is not any one of the registered IP addresses in the whitelist, dropping the request from the client terminal.

18. The apparatus of claim 14, wherein the redirect message includes cookie information containing the redirect URL.

19. The method of claim 18, wherein the cookie information is created using a source IP address of the packet.

20. The method of claim 14, wherein the redirect message is transmitted using an HTTP (HyperText Transfer Protocol) 302 redirect response to the client terminal.

21. The method of claim 14, wherein the redirect message is transmitted using an HTTP 200 OK response having a script to move to the redirect URL to the client terminal.

22. The method of claim 21, wherein the script is written in a Java script or visual basic (VB) script.

23. The method of claim 14, wherein the redirect message is transmitted in an HTTP 200 OK response to the client terminal, wherein the redirect message includes an HTML (HyperText Markup Language) page having a link to the redirect URL.
